(19) United States
(12) Patent Application Publication
(10) Pub. No.: US 2015/0065236 A1
(43) Pub. Date: Mar. 5, 2015

(54) INFORMATION PROCESSING APPARATUS, SYSTEM, METHOD, AND MEDIUM

(71) Applicant: NINTENDO CO., LTD., Kyoto (JP)

(72) Inventor: Koichi HAYASHIDA, Kyoto (JP)

(73) Assignee: NINTENDO CO., LTD., Kyoto (JP)

(21) Appl. No.: 14/142,242

(22) Filed: Dec. 27, 2013

(30) Foreign Application Priority Data
Sep. 5, 2013 (JP) 2013-184527

(51) Int. Cl. A63F 13/63; A63F 13/87; A63F 13/45

(52) U.S. Cl. CPC A63F 13/63; A63F 13/45; A63F 13/87
USPC 463/29

(57) ABSTRACT

A information processing apparatus includes: a game processing unit; a determining unit that determines whether a predetermined condition is satisfied in game processing; a permitting unit that permits the use of a predetermined raw content when the condition is satisfied; a user content generating unit that generates user content for communication between users according to a process including reflecting the raw content permitted for use on the user content and also including processing a portion of the user content on which the raw content is reflected; and a user content transmitting unit that transmits the user content to another device.

### CROSS-REFERENCE TO RELATED APPLICATION

This application is based upon and claims the benefit of priority of the prior Japanese Patent Application No. JP2013-184527, filed on Sep. 5, 2013, the entire contents of which are incorporated herein by reference.

### FIELD

The present disclosure relates to a technique for communication between users.

### BACKGROUND AND SUMMARY

In the related art, a message board or the like for facilitating communication between users by allowing the game users to share the flow of game play, strategic information on the game play and the like has been provided. Moreover, in such a message board or the like, various types of content such as still images, videos, or audios in addition to text content data are posted and inserted.

However, in such a message board, there is such a tendency that users who can create content that attracts the attention of other users post frequently, whereas users who think it is difficult to create content that attracts the attention of other users do not play a participatory role a lot and remain as content viewer and less frequently create or post their content.

According to an aspect of the present disclosure, there is provided an information processing apparatus including: a game processing unit that performs game processing according to a user operation; a determining unit that determines whether a predetermined condition is satisfied in the game processing; a permitting unit that permits the use of a predetermined raw content when the condition is determined to be satisfied; a user content generating unit that generates user content (user-generated content) for communication between users according to a process including reflecting the raw content permitted for use on the user content and also including processing a portion of the user content on which the raw content is reflected; and a user content transmitting unit that transmits the user content to another device.

The present disclosure may be grasped as an information processing apparatus, a method executed by a computer, a program for causing the computer to execute processing. Moreover, the present disclosure may be grasped as a recording medium which can be read by an apparatus, a machine, or the like other than the computer and in which such a program is recorded. Here, the recording medium readable by the computer or the like means a recording medium that stores information such as data, programs, or the like according to electrical, magnetic, optical, mechanical, or chemical actions and that can be read from a computer or the like.

### BRIEF DESCRIPTION OF THE DRAWINGS

FIG. 1 is a diagram illustrating a schematic configuration of an information processing system according to an embodiment;

FIG. 2 is a diagram illustrating a schematic hardware configuration of the information processing system according to the embodiment;

FIG. 3 is a diagram illustrating a schematic functional configuration of an information processing apparatus according to the embodiment;

FIG. 4 is a diagram schematically illustrating a raw content management table according to the embodiment;

FIG. 5 is a diagram illustrating an example of raw content used in the embodiment;

FIG. 6 is a flowchart illustrating the flow of information processing according to the embodiment;

FIG. 7 is a diagram illustrating a raw content list display picture used in the embodiment; and

FIG. 8 is a diagram illustrating a user content editing picture used in the embodiment.

### DETAILED DESCRIPTION OF NON-LIMITING EXAMPLE EMBODIMENTS

Hereinafter, an embodiment of the present disclosure will be described based on the drawings. The embodiment described below illustrates an example in which the present disclosure is embodied, and the present disclosure is not limited to the specific configuration described below. When the present disclosure is embodied, the specific configuration may be appropriately employed according to an embodiment.

<Configuration of System and Apparatus>

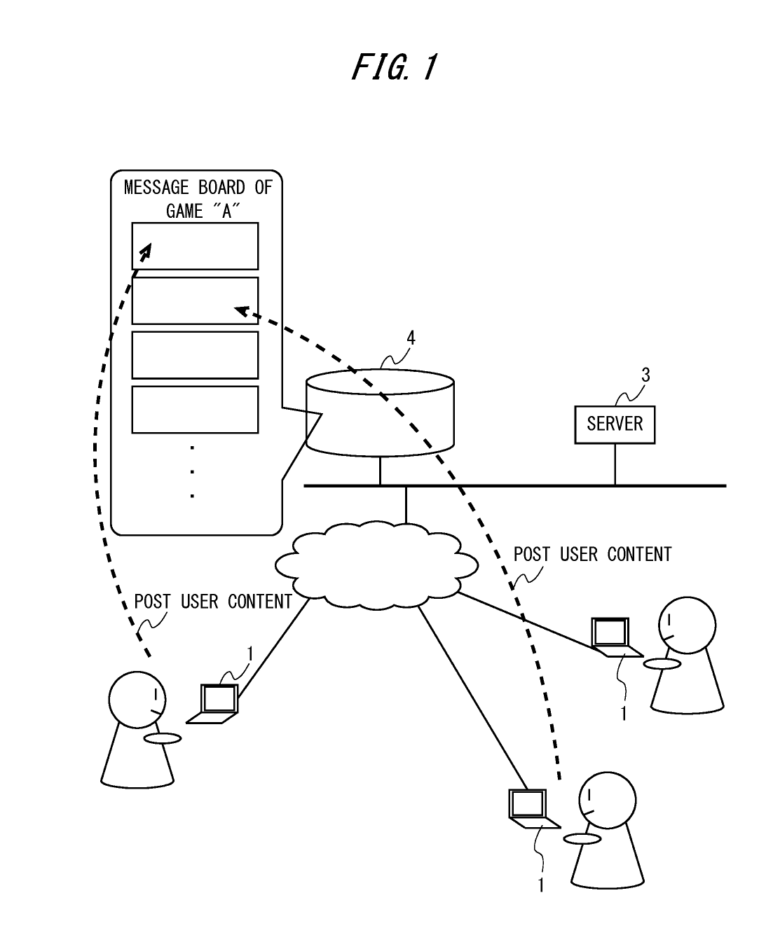

FIG. 1 is a diagram illustrating a schematic configuration of an information processing system according to the present embodiment. The information processing system according to the present embodiment includes an information processing apparatus 1, a server 3, and a database 4 that are communicably connected via a network such as the Internet.

The information processing apparatus 1 is a game machine or the like used by a user. Various types of apparatuses can be used as the game machine. Examples of the game machine include a stationary game machine, a portable game machine, a smartphone, wearable electronic equipment, and the like, and the type thereof is not particularly limited. The user can play a game by causing the information processing apparatus 1 to execute game processing based on a game program. Moreover, the user can create and post user content by causing the information processing apparatus 1 to execute a user content generation and posting application described later.

In the information processing system according to the present embodiment, the server 3 is a computer that mediates communication between users who play a game by receiving, managing, and distributing the user content that the user posted using the information processing apparatus 1. The server 3 may be realized as a single apparatus and may be realized by a plurality of computers, for example, by being installed on a cloud. Moreover, the database 4 manages the user content received by the server 3 in association with a predetermined game.

The system according to the present embodiment facilitates communication between users playing a game by posting and distributing user content with the aid of the information processing apparatus 1, the server 3, and the database 4 included therein. In the present embodiment, the user content is a bitmap image having the size of 320×120 pixels. Content of various forms may be employed as the user content. For example, the user content may include sound data, movie data, text data, and the like in addition to the still image data employed in the present embodiment.

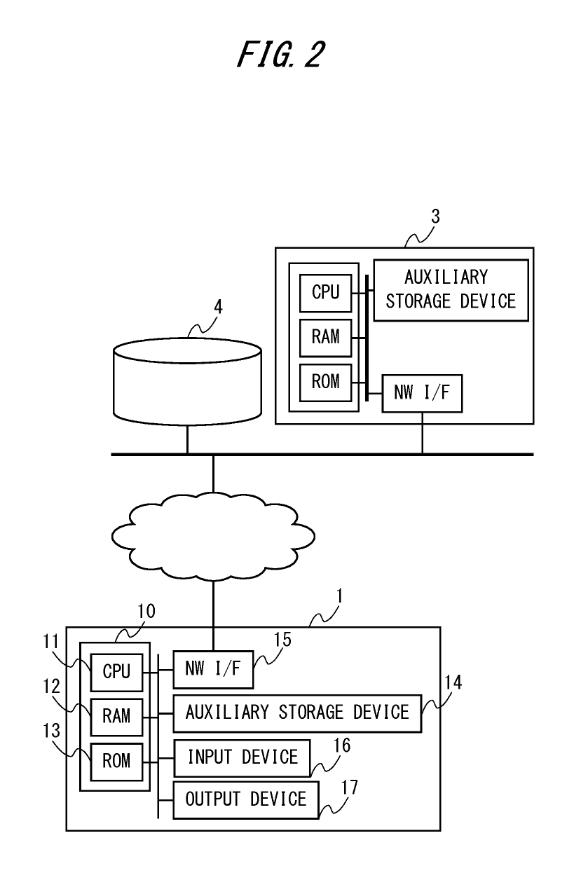

FIG. 2 is a diagram illustrating a schematic hardware configuration of the information processing system according to the present embodiment. The information processing apparatus 1 is an information processing apparatus in which a central processing unit (CPU) 11, a random access memory (RAM) 12, a read only memory (ROM) 13, an auxiliary storage device 14, a network interface 15 for performing communication with an external device via a network, an input device 16, and an output device 17 are electrically connected. With regard to specific hardware configuration of the information processing apparatus 1, constituent components may be appropriately omitted, substituted, or added according to an embodiment.

The CPU 11 is a central processing device and controls respective constituent components included in the information processing apparatus 1 such as the RAM 12 and the auxiliary storage device 14 by processing commands and data deployed in the RAM 12, the ROM 13, and the like. The RAM 12 is a main storage device and is controlled by the CPU 11 so that various types of commands and data are written and read. That is, the CPU 11, the RAM 12, and the ROM 13 form the control unit 10 of the information processing apparatus 1.

The auxiliary storage device 14 is a nonvolatile storage device, and mainly, information (for example, various types of data used by the information processing apparatus 1 other than an operating system (OS) of the information processing apparatus 1 loaded to the RAM 12 and various programs for executing processes described later) that should remain even when the information processing apparatus 1 is turned off is written and read. An electrically erasable programmable ROM (EEPROM), a hard disk drive (HDD), and the like can be used as the auxiliary storage device 14, for example. Moreover, a portable medium that is removably attached to the information processing apparatus 1 may be used as the auxiliary storage device 14. Examples of the portable medium include an EEPROM-type memory card, a compact disc (CD), a digital versatile disc (DVD), and a Blu-ray (registered trademark) disc (BD). A portable auxiliary storage device 14 and a non-portable auxiliary storage device 14 may be used in combination.

As the input device 16, various devices such as buttons, a lever, a keyboard, an acceleration sensor, an angular velocity sensor, a touch panel, or a touch panel-type display can be employed. A touch panel-type display is one type of the input device 16 of the information processing apparatus 1 as well as the output device 17 that displays images. The user can input handwriting by touching the surface of the touch panel-type display with a touch pen, a finger, or the like. A resistive touch panel or a capacitive touch panel, for example, may be employed in the touch panel-type display. In addition to this, an optional touch panel may be used in the touch panel-type display. Although the information processing apparatus 1 according to the present embodiment is configured to receive an input such as a drawing, a handwritten character, or a gesture via the touch panel-type display, an input may be received via an input device (for example, a tablet computer or the like) connected to a network or the like.

The server 3 is a computer in which a CPU, a RAM, a ROM, an auxiliary storage device, and a network interface are electrically connected. With regard to specific hardware configuration of the server 3, constituent components may be appropriately omitted, substituted, or added according to an embodiment similarly to the information processing apparatus 1.

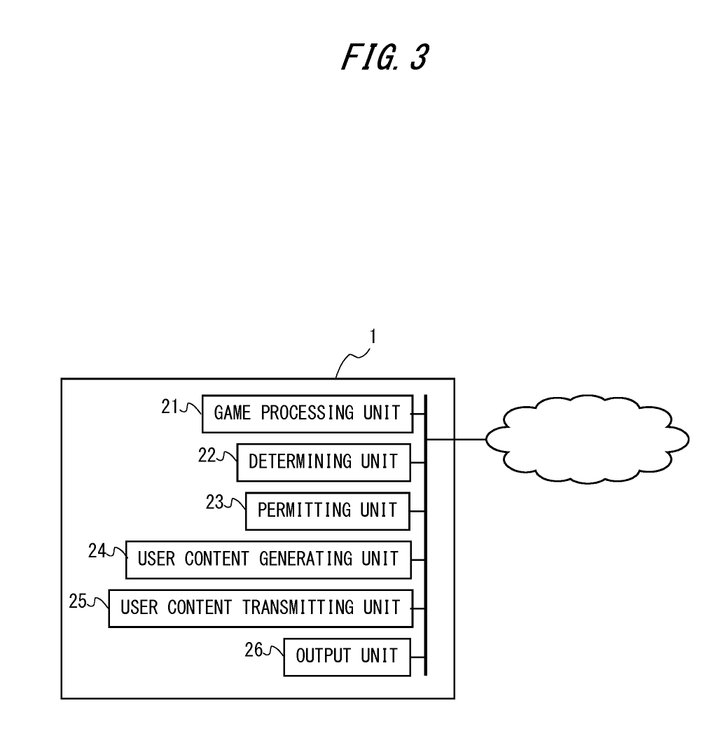

FIG. 3 is a diagram illustrating a schematic functional configuration of the information processing apparatus 1 according to the present embodiment. The information processing apparatus 1 according to the present embodiment functions as an information processing apparatus that includes a game processing unit 21, a determining unit 22, a permitting unit 23, a user content generating unit 24, a user content transmitting unit 25, and an output unit 26 when the CPU 11 analyzes and executes various programs deployed in the RAM 12. In the present embodiment, although an example in which all of these functions are realized by the CPU 11 has been described, part of all of these functions may be realized by one or a plurality of dedicated processors. Moreover, the respective functional units included in the information processing apparatus 1 may be installed on a cloud, the server 3, or the like, for example. Further, these functional units may be realized by a plurality of items of software rather than a single item of software.

The game processing unit 21 performs game processing by executing a game program while reflecting the input based on the user operation on various parameters of the game program.

In the game processing, the determining unit 22 determines whether at least one of one or a plurality of conditions that is set in advance in a raw content management table.

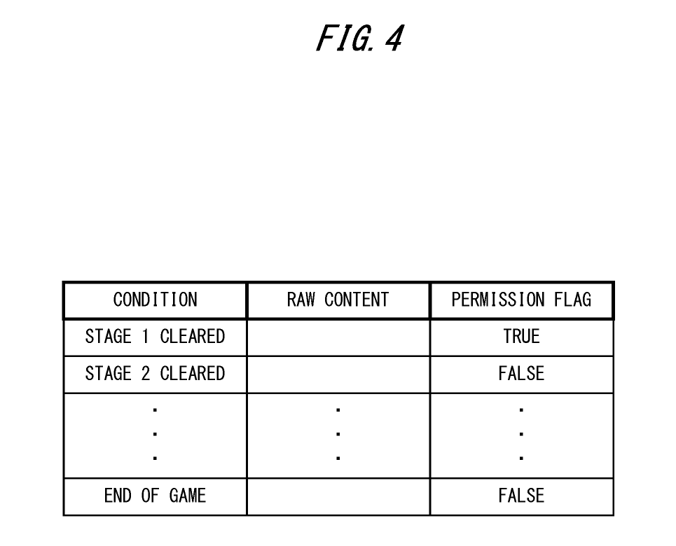

FIG. 4 is a diagram schematically illustrating the raw content management table according to the present embodiment. In the present embodiment, the raw content management table is used in order to manage raw content corresponding to one or a plurality of conditions set in advance. The structure for managing the correspondence between conditions and raw content and a use permission state of raw content may employ a structure other than the raw content management table described in the present embodiment.

The raw content management table includes conditions that are to be satisfied in game processing, raw content (or a storage location of the raw content) that is permitted for use when the conditions are satisfied, and a use permission flag of the raw content. The raw content is recorded in a recording medium from which the information processing apparatus 1 can acquire data locally or remotely. When a local recording medium (the auxiliary storage device 14) is used, the recording medium in which the raw content is recorded may be a medium incorporated in the information processing apparatus 1 and may be a portable medium that is removably attached to the information processing apparatus 1, for example.

The conditions managed by the raw content management table include clearing of a predetermined stage during a game, acquisition of a predetermined item (or the raw content itself), satisfying of predetermined other conditions during a stage, arrival at the end of a game, and playing of a game for a predetermined period or longer. In the present embodiment, since it is possible to generate user content using raw content that is permitted for use when such conditions are satisfied and to post the user content, it is possible to inform other users viewing the user content of the fact that the posting user satisfied the conditions (for example, the user cleared a difficult stage or acquired a rare item). Thus, the raw content may include content associated with the game related to the game processing.

Moreover, the combination of conditions and raw content may be appropriately added or deleted. In the present embodiment, a combination of new conditions and raw content can be added or deleted by updating the raw content management table. The raw content management table can be updated via a network.

When it is determined that a certain condition is satisfied, the permitting unit 23 permits the user of raw content corresponding to the satisfied condition among a plurality of items of raw content managed by the raw content management table.

Here, permitting the use of raw content means permitting the user of the game to use the same in generating user content, and in other words, permitting the user to reflect (for example, paste) or process the raw content. Hereinafter, a process of pasting an image will be described as an example of the process of reflecting the raw content on the user content. However, the method of using the raw content in the user content is not limited to pasting. Although use permission may be performed, for example, in a method of setting a use permission flag to the raw content in the raw content management table, other methods may be employed. Moreover, the data of raw content permitted for use may be included in advance in the game program and may be included in other programs. Further, the data may be downloaded via a network when the use thereof is permitted and may be downloaded when the data is used.

The user content generating unit 24 performs a process of pasting the raw content permitted for use on the user content and a process of drawing on the user content according to the user input to thereby generate user content for communication between users. Here, the user may change the size or the attitude of the raw content during the pasting process and may perform processing on a portion of the user content in which the raw content is pasted during the drawing process. Moreover, the user may use a plurality of items of raw content for one item of user content. The same raw content may be used multiple times for one item of user content, and a plurality of different types of raw content may be used for one item of user content.

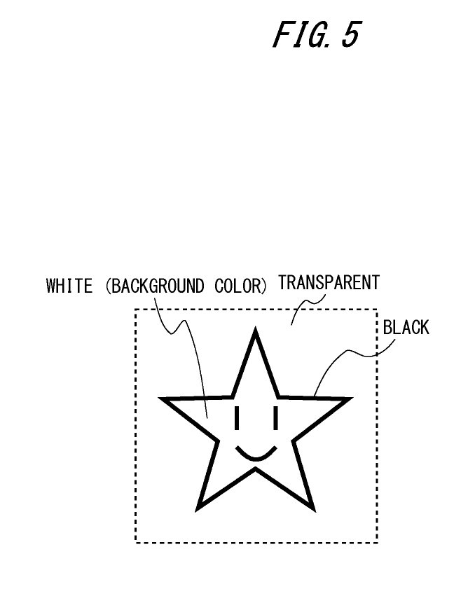

FIG. 5 is a diagram illustrating an example of raw content used in the present embodiment. The user can use raw content in generating the user content described above.

Since the raw content according to the present embodiment is a bitmap image as described above, the raw content data includes data indicating vertical and horizontal sizes and data capable of specifying color information of each portion (pixel) within the raw content. For example, when the user content that can be generated is a monochrome binary image, the raw content data includes information capable of specifying whether respective portions of the raw content are black, white (background color), or transparent color. When raw content including transparent color is pasted on user content, a portion in which transparent color is used is not overwritten but the existing content remains. Thus, the user can use the raw content in the same sense as a stamp. Moreover, by using part of constituent colors as the same color (for example, white color) as the default background color of the user content, when raw content is pasted so as to be superimposed on another pasted raw content or a drawing portion, since the existing content is rewritten in the background color, the users can easily recognize the pasted raw content.

When raw content is an image, this image may be a picture of a game character, a balloon (remarks may be drawn in the balloon), a frame, a figure, or the like, for example. The user may broaden the width of expression of user content by combining a plurality of types of raw content. Moreover, the plurality of items of raw content may have different sizes. The more difficult the satisfied conditions which the raw content is associated with, the larger the size of the raw content or the more popular the character of the raw content.

The size of the raw content may exceed the size of the user content. For example, the user content posed in the present embodiment is a bitmap image having the size of 320×120 pixels, raw content having the size of 200×200 pixels may be prepared. Portions exceeding (protruding) from the region of user content are cut (and are not recorded in user content).

The user content transmitting unit 25 transmits the user content to the server 3 to publicize the user content so that the user content can be acquired from devices of other users who are not playing the game associated with the game processing. Here, the other user devices may be of the same type (for example, a game machine of the same model) as the information processing apparatus 1 and may be of a type (for example, a personal computer, a smartphone, or the like when the information processing apparatus 1 is a game machine) different from the information processing apparatus 1. In the present embodiment, although publicizing of user content is realized by transmitting user content to the server 3 that other user devices can access, the publicizing of user content may be realized by other means. For example, the information processing apparatus 1 may publicize theuser content by transmitting the user content to other devices using a peer-to-peer (P2P) technique.

The output unit 26 outputs a list of items of raw content that are permitted for use by the permitting unit 23. Moreover, the output unit 26 outputs raw content so that users can detect the presence of raw content that is still not permitted for use among the plurality of items of raw content managed by the raw content management table.

<Process Flow>

Next, the flow of the process executed in the present embodiment will be described. Specific content and processing order of the process illustrated in the flowchart according to the present embodiment are examples for implementing the present disclosure. The specific processing content and processing order may be appropriately selected according to the embodiment of the present disclosure.

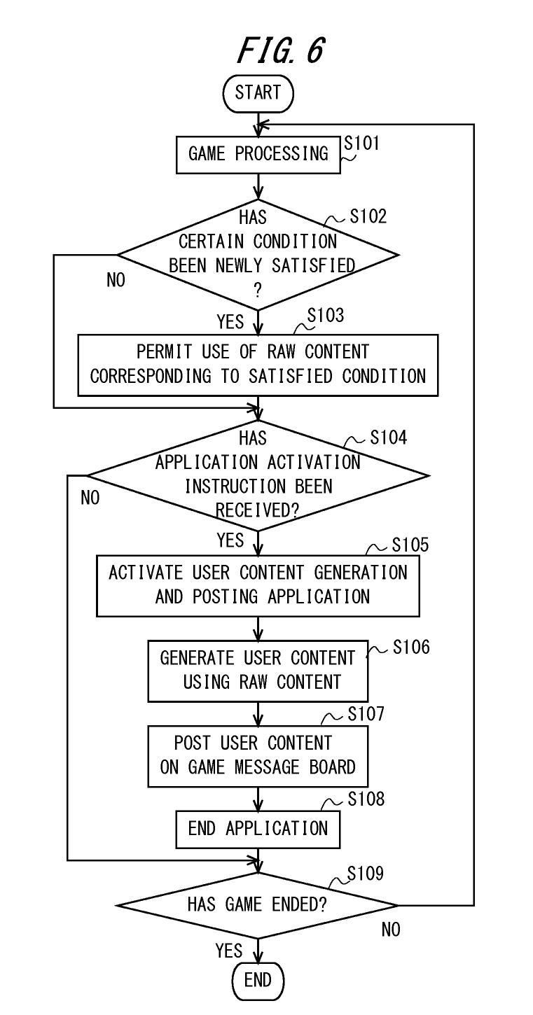

FIG. 6 is a flowchart illustrating the flow of information processing according to the present embodiment. The process illustrated in this flowchart is executed when the information processing apparatus 1 receives an instruction to start game processing.

In step S101, the game processing is executed. The GPS reception function 21 of the information processing apparatus 1 loads a game program desired by the user into the RAM 12 by reading from the auxiliary storage device 14 or downloading via a network and executes the game program to thereby perform game processing. Here, the game processing progresses according to a user operation received via the input device 16 such as a touch panel-type display. The progress state of the game is managed using data (flags, parameters, or the like) during the game program. After that, the process proceeds to step S102.

In step S102, it is determined whether a certain condition is satisfied newly during the game processing. The determining unit 22 determines whether the present state of the game satisfies at least one condition by comparing the data for managing the game state with one or a plurality of conditions (see FIG. 4) set in advance in the raw content management table. When it is determined that there is not a newly satisfied condition, the process proceeds to step S104. On the other hand, when it is determined that the game state satisfies a certain condition newly, the process proceeds to step S103.

In step S103, the use of raw content corresponding to the satisfied condition is permitted. The permitting unit specifies raw content corresponding to the condition satisfied in step S102 by referring to the raw content management table and permits the use of the raw content. After that, the process proceeds to step S104.

In step S104, it is determined whether an instruction to activate a user content generation and posting application is received. The application activation instruction may be an instruction based on a user operation and may be an activation instruction that is issued automatically according to the progress of the game. For example, when the game includes a plurality of stages, the application activation instruction may be issued when a certain stage ends. Moreover, an interface (a button or the like) for receiving a user operation of inputting an application activation instruction may be displayed when the stage ends. By doing so, it is possible to encourage the user to generate and post user content using the raw content that is permitted for use recently at a predetermined point in time during the progress of the game. When it is determined that the activation instruction is not received, the process proceeds to step S109. On the other hand, when it is determined that the activation instruction is not received, the process proceeds to step S105.

In step S105, the user content generation and posting application is activated. The user content generation and posting application in the present embodiment corresponds to the output unit 26, the user content generating unit 24, and the user content transmitting unit 25. In the present embodiment, an example in which the processes of the output unit 26, the user content generating unit 24, and the user content transmitting unit 25 are performed by the user content generation and posting application prepared separately from the game program is described. However, the processes of the output unit 26, the user content generating unit 24, and the user content transmitting unit 25 may be performed by software included in the game program. When the user content generation and posting application is activated, the raw content management table data is transferred from the game program to the application. After that, the process proceeds to step S106.

In step S106, the user content is generated by the user content generation and posting application. The user content generating unit 24 generates user content for communication between the game users according to a process including pasting of raw content on user content and drawing according to the user input. In this way, the user can generate and post a bitmap image as user content using the input device 16 such as a touch panel-type display.

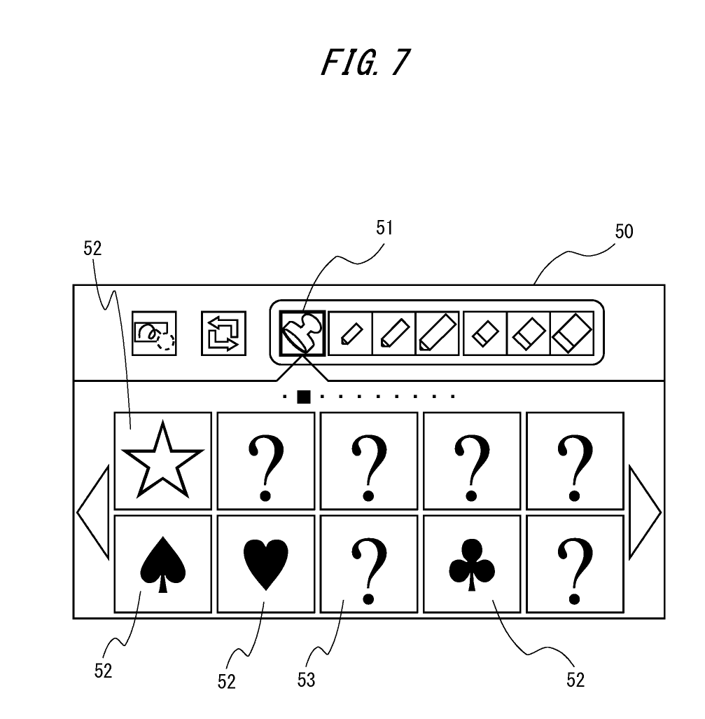

FIG. 7 is a diagram illustrating a raw content list display picture 50 used in the present embodiment. The output unit 26 outputs the raw content raw content list display picture 50 upon detecting a touch operation on a raw content tool button 51 after the application is activated. In the list display picture 50, icons 52 representing the items of raw content that have been permitted for use are displayed in arrangement. The icons of the items of raw content permitted for use recently are displayed to attract the user's attention in order to encourage the user to use the same. For example, the user's attention may be attracted by displaying the icons with a bright border or background or so as to blink. In this list, the presence of raw content (that is, that the user has not acquired) that is not permitted for use because conditions are not satisfied yet is also displayed so that the user can understand that the use is not permitted (that the content is not acquired). In the present embodiment, the presence of non-acquired raw content is displayed by a “?” icon 53 indicating the non-acquired raw content. However, a display method for allowing the user to understand the presence of non-acquired raw content may be another method other than the method illustrated in the present embodiment. For example, a method of displaying non-acquired raw content in silhouette, a method of displaying the number of items of non-acquired raw content, e.g., “non-acquired content: xxx items”, and other methods may be employed.

The user selects raw content by touching on a position at which desired raw content is displayed in a state where the raw content list display picture 50 is displayed on a touch panel-type display, for example. When the raw content is selected, a user content editing picture 60 is displayed.

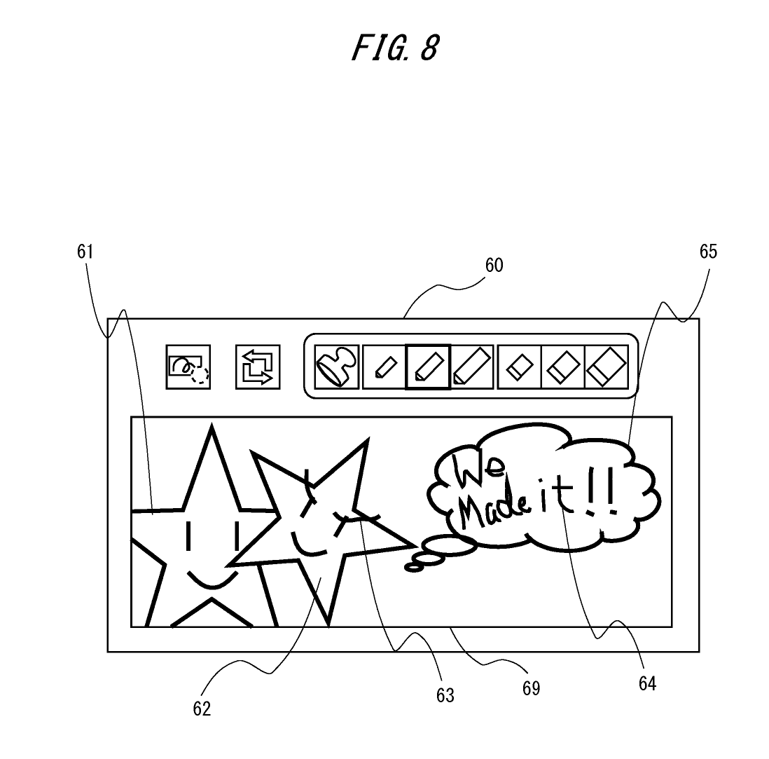

FIG. 8 is a diagram illustrating the user content editing picture 60 used in the present embodiment. In the user content editing picture 60, user content being edited, drawing pen icons, an eraser icon, and the like are displayed. The user can paste raw content by touching on a desired position within a region 69 where user content being edited is displayed. In this case, the pasting position of the raw content being touched may be finely adjusted by determining a touch position when the touch operation ends (when removal of a finger, a touch pen, or the like is detected) as the pasting position without deciding the pasting position when the touch operation continues (when contact of a finger, a touch pen, or the like on a touch panel is still being detected). When the touch position deviates from the user content display region with the touch operation continued, pasting of the raw content may be canceled.

In pasting of raw content on user content, the user may change the size and the attitude (angle) of the raw content to be pasted in the user content using the input device 16. For example, a pasted image 61 protrudes from the user content region with its size enlarged and a portion thereof is cut. Moreover, a pasted image 62 is pasted with its attitude (angle) changed. An operation based on a button, a lever, and the like may be allocated to changing of the size and the attitude, and a gesture detected by the input device 16 such as a touch panel-type display may be allocated.

In a drawing process based on the user input, the user can draw a picture 63, a character 64, and the like by himself (or herself) using the input device 16 such as a touch panel-type display. Further, the user can draw on a portion of the user content in which raw content is pasted (see reference numeral 63 of FIG. 8). That is, the user can freely process the user content after the image provided as raw content is pasted on the user content. Specifically, the user can easily generate user content including a complex design by adding changes such as adding a certain figure (including lines and dots), erasing a figure, adding colors, or changing colors after the raw content is pasted on the user content. However, it is assumed that the user cannot alter the raw content itself managed by the raw content management table.

Moreover, the user can transmit a message to other users viewing the user content by writing a handwritten comment 64 in the user content in the drawing process. The handwritten comment 64 may be inserted in a portion 65 in which balloon-type raw content is pasted, for example. This message may be an impression on the game or an attacking method and may be a joke or the like created using the raw content. Moreover, such a comment may be added to user content in a test data form rather than a handwritten data form. When the user content is generated, the process proceeds to step S107.

In step S107, the user content is posted. The user content transmitting unit 25 transmits (uploads) the user content generated in step S106 to the server 3 so as to be publicized on a message board associated with the game in which the use of the raw content used in generation of the user content is permitted. By doing so, the user content transmitting unit 25 enables the user content to be acquired from other user devices.

As described above, in the present embodiment, the raw content management table data is transferred from the game program to the user content generation and posting application. An application called from a certain game posts user content on a message board of the game only (that is, posting on message boards of the other games is inhibited).

That is, in the present embodiment, user content that uses raw content permitted for use in a game “A” can be posted on a message board of the game “A”, and user content that uses raw content permitted for use in a game B can be posted on a message board of the game B. In this way, the raw content included in the user content posted on a message board for a predetermined game can be limited to raw content that is permitted for use in the game only. Moreover, users viewing the post can understand their game progress states, and the motivation for causing the users to progress the game can be increased. However, with regard to viewing of a message board, any user (user who is not playing the game associated with the game) can view the message board.

Here, other methods may be employed as a method for limiting raw content included in the user content posted on a message board for a predetermined game to the raw content permitted for use in the game only. For example, game identification information indicating a game associated with conditions and raw content may be further stored in the content management table (see FIG. 4) so that the user content generation and posting application limits the posting destination of the created user content by referring to the game identification information. The application limits the raw content to be used to raw content that is associated with the game identification information corresponding to a game in execution. When such a method is employed, items of raw content associated with a plurality of games can be managed by one content management table.

In the present embodiment, although a place that is electronically provided for posting and viewing of user content is referred to as a “message board,” a specific form or system is not limited to a so-called Internet message board. The place provided electronically for posting and viewing of user content may be realized in various forms such as, for example, a timeline, a community, a group, or a mailing list. When the user content is posted, the process proceeds to step S108.

In steps S108 and S109, the user content generation and posting application ends and it is determined whether the game is to be ended. When it is determined that the game is not to be ended (the game is to be continued), the process proceeds to step S101. That is, the process illustrated in this flowchart is repeatedly executed until the game ends. When it is determined that the game is to be ended, the process illustrated in this flowchart ends.

<Variation>

As described above, the user content is not limited to the still image data employed in the present embodiment, and various forms of content may be employed. For example, the user content may include sound data, movie data, text data, and the like in addition to the still image data. Thus, the raw content is not limited to an image, and may be audio content, video content, text content, or the like. For example, the raw content provided as audio data may be the sound of a game character, a music used during the game, a sound effect during the game, and the like.

The raw content may be combined with other existing content and be used in user content. For example, when the raw content is audio data or movie data, the user content may be generated by superimposing or linking the audio data or the movie data as the raw content on or to audio or video that is recorded by the user.

When the raw content is a still image data or movie data, the raw content may be monochrome content or two or multiple-color content. When such raw content is used in user content that is displayed with multiple colors, the color of the raw content may be switched. Switching of the raw content color may be realized, for example, by sequentially switching patterns having colors prepared in advance for the same image according to a user operation. The switching sequence may be circular so that the last pattern in the pattern arrangement returns to the first pattern. Moreover, the raw content data may be stored as a plurality of items of image data prepared by the number of pattern colors, and one item of image data and a plurality of items of color designation data for the image data may be stored.

As for a raw content selecting method, a method of sequentially switching raw content according to the user operation may be employed. For example, when a plurality of items of raw content (for example, a plurality of images with different looks or poses) is prepared for the same character, these items of raw content may be sequentially switched according to the user operation.

In the embodiment described above, although the raw content included in the user content posted on a message board for a predetermined game is limited to raw content that is permitted for use in the game only, the raw content may be usable in user content for an optional game message board.

In the embodiment, although an example in which the user content generation and posting application is activated during the game processing has been described, the activation of the application is not limited to during the game processing. In particular, when the message board in which the raw content can be used is not limited, the user content generation and posting application may be designated directly from a menu picture of the OS so as to be activated at an optional time other than during the game processing.

When a plurality of user accounts is set in one information processing apparatus (game machine), the use of raw content may be permitted for each user account and may be permitted for all accounts set in the information processing apparatus.

What is claimed is:

1. An information processing apparatus comprising:
a game processing unit that performs game processing according to a user operation;
a determining unit that determines whether a predetermined condition is satisfied in the game processing;
a permitting unit that permits the use of predetermined raw content when the condition is determined to be satisfied;
a user content generating unit that generates user content for communication between users according to a process including reflecting the raw content permitted for use on the user content and also including processing a portion of the user content on which the raw content is reflected; and
a user content transmitting unit that transmits the user content to another device.

2. The information processing apparatus according to claim 1, wherein
the determining unit determines whether at least one of a plurality of predetermined conditions is satisfied, and
the permitting unit permits the use of raw content corresponding to the satisfied condition from among a plurality of items of raw content.

3. The information processing apparatus according to claim 1, wherein
the user content transmitting unit transmits the user content to a server device so that the user content is publicized so as to be acquired from another user device.

4. The information processing apparatus according to claim 1, wherein
the user content transmitting unit transmits the user content so that the user content can be acquired from another user device that is not playing a game associated with the game processing.

5. The information processing apparatus according to claim 1, wherein
the permitting unit permits the use of the raw content for use in generating user content that is publicized on a message board prepared for a game associated with the game processing.

6. The information processing apparatus according to claim 1, wherein
the user content generating unit reflects one or a plurality of items of raw content in one item of user content.

7. The information processing apparatus according to claim 1, wherein
the raw content is an image, and
the user content generating unit further executes a process of changing a size or an attitude of the raw content during the reflecting.

8. The information processing apparatus according to claim 1, wherein
the raw content is an image, and
the user content generating unit further executes a process of drawing according to an input of the user.

9. The information processing apparatus according to claim 1, wherein
the user content generating unit further executes a process of adding a handwritten comment to the user content according to an input of the user.

10. The information processing apparatus according to claim 1, wherein
the user content generating unit further executes a process of adding a comment to the user content according to text data.

11. The information processing apparatus according to claim 1, further comprising:
an output unit that outputs a list of items of raw content that are permitted for use by the permitting unit.

12. The information processing apparatus according to claim 11, wherein
the output unit implement output so that the user can understand the presence of raw content that is not yet permitted for use from among the plurality of items of raw content.

13. The information processing apparatus according to claim 1, wherein
the raw content is content that is not permitted for the user to modify.

14. The information processing apparatus according to claim 1, wherein
the raw content is content that is related to a game associated with the game processing.

15. The information processing apparatus according to claim 1, wherein
when the condition is determined to be satisfied, the permitting unit permits a user who satisfies the condition in the game processing to use a predetermined item of raw content.

16. A system comprising:
a game processing unit that performs game processing according to a user operation;
a determining unit that determines whether a predetermined condition is satisfied in the game processing;
a permitting unit that permits the use of a predetermined raw content when the condition is determined to be satisfied;
a user content generating unit that generates user content for communication between users according to a process including reflecting the raw content permitted for use on the user content and also including processing a portion of the user content on which the raw content is reflected; and
a user content publicizing unit that publicizes the user content so as to be acquired from another user device.

17. A method for causing a computer to execute:
game processing according to a user operation;
determining whether a predetermined condition is satisfied in the game processing;
permitting the use of a predetermined raw content when the condition is determined to be satisfied;
generating user content for communication between users according to a process including reflecting the raw content permitted for use on the user content and also including processing a portion of the user content on which the raw content is reflected; and
transmitting the user content to another device.

18. A computer readable non-transitory medium recorded with a program for causing a computer to function as:
a game processing unit that performs game processing according to a user operation;
a determining unit that determines whether a predetermined condition is satisfied in the game processing;
a permitting unit that permits the use of a predetermined raw content when the condition is determined to be satisfied;
a user content generating unit that generates user content for communication between users according to a process including reflecting the raw content permitted for use on the user content and also including processing a portion of the user content on which the raw content is reflected; and
a user content transmitting unit that transmits the user content to another device.
